(19) United States
(12) Patent Application Publication
(10) Pub. No.: US 2014/0248191 A1
(43) Pub. Date: Sep. 4, 2014

(54) REACTOR ASSEMBLY FOR IMPROVING REACTION BETWEEN TWO IMMISCIBLE PHASES FOR METAL REDUCTION OF HYDROCARBONS

(71) Applicant: INDIAN OIL CORPORATION LTD., Kolkata, West Bengal (IN)

(72) Inventors: Madhusudan Sau, Faridabad (IN); Ganesh V. Butley, Faridabad (IN); Yamini Gupta, Faridabad (IN); Karumanchi Ramesh, Faridabad (IN); Mainak Sarkar, Faridabad (IN); Arangarasu Arun, Faridabad (IN); Brijesh Kumar, Faridabad (IN); Ravinder Kumar Malhotra, Faridabad (IN)

(21) Appl. No.: 14/347,534

(22) PCT Filed: Oct. 12, 2012
(86) PCT No.: PCT/IB2012/002034

§ 371 Date: Mar. 26, 2014

(30) Foreign Application Priority Data
Oct. 12, 2011 (IN) 1318/KOL/2011

(51) Int. Cl. B01J 19/08

(52) U.S. Cl. CPC B01J 19/088; B01J 2219/0877; B01J 2219/0805
USPC 422/186.04

(57) ABSTRACT

A reactor assembly (1) for improving reaction between two immiscible phases for metal reduction of hydrocarbons is disclosed, which is a modification of a CSTR type reactor assembly. A third gaseous phase is also present in the reactor. Metal plates (5) are provided, mounted on supporting rods (6) which are electrically insulated from the rest of the reactor. The metal plates are made of the same metal to avoid detachment of metal atoms from metal plates. The metal plates serve as the means of transferring only the electrons from the metal plates to the liquids in which they are fully immersed, so that the reaction is made more efficient.

### FIELD OF THE INVENTION

The invention relates to reactors used for extraction of metals from petroleum oils, in general, and to a reactor assembly for improving reaction between two immiscible phases for metal content reduction of hydrocarbons in particular.

### BACKGROUND OF THE INVENTION AND ITS PRIOR ART

Reactive extraction of metals from petroleum oils containing metals by oxidizing and then using aqueous phase as extracting medium is known as an effective process for metal reduction for hydrocarbon oils. Various chemical reagents are usually deployed in the aqueous phase to facilitate the reaction and subsequent extraction in conjunction with suitable reaction temperature and homogeneous or heterogeneous catalysts to speed up the reaction rate.

Various types of reactors are used for carrying out these reactions, where there are three phases contacting between two immiscible liquids and one gaseous phase. This type of contacting is essential and is the starting point for the reaction mechanism between these phases. A continuous stirred tank type of reactor with agitator and baffle assembly is the most commonly used reactor, both for studying the mechanism of reactions and also in industrial practices. The reaction can be accelerated by various means. Use of electricity is very common to achieve this end. Use of electrochemical treating of hydrocarbon for metal containing petroleum streams is one such widely practised method.

U.S. Pat. Nos. 5,911,869, 5,879,529, 5,855,764 and 5,529,684 by Exxon Research and Engineering Co disclose the use of electrochemical treating of hydrocarbons for metal reductions. In this method electric current is passed through a intimate mixture of hydrocarbon (containing metal compounds) and aqueous electrolysis medium containing various chemical reagents with alkaline pH at sufficient cathodic potential (against standard calomel electrode) to aid the oxidative removal of metals from hydrocarbons.

U.S. Pat. No. 5,817,228 (Exxon Research and Engineering Co) discusses similar system using of sufficient anodic potential (against standard calomel electrode) in acidic pH range.

U.S. Pat. No. 5,911,859 (Exxon Research and Engineering Co) discloses the design of three dimensional electrode assembly and undivided electrochemical cell for using in metal reduction of hydrocarbons. In the electrochemical way of using electrical energy, electrical potential properties of electrode metal have to be taken in to account. Additionally, the use of standard electrode becomes essential. The electrical energy can be utilized in two ways: first in electrochemical way and another in electrical energy as such. The present invention discloses the use of only electrical energy and ways to ensure its use in form of flow of electrons and methods of injecting electric current in the reaction system for enhancing the reaction rate of oxidative and reactive extraction of metals from the hydrocarbons.

The prior art, as discussed above, shows the use of electricity to enhance the rate and efficiency of the metal extraction reaction, but invariably the electricity has been used there for electrochemical reaction.

### OBJECTS OF THE INVENTION

The continuous demetallation of heavy hydrocarbons by reactive absorption by the use of phase transfer catalyst and electric current is being extensively studied. The process is not matured yet and there is a scope of improvement. The current state of process suffers from the slow reaction rate and less efficient use of electric current. The current invention is aimed at increasing the efficiency of the process by novel use of electric current for the process and provides a innovative reactor assembly for attaining the said purpose.

An object of the present invention is to provide a novel reactor assembly which can increase the reaction rate between three phases containing two immiscible liquid phases and one gaseous phase.

Another object of the invention is to provide a reactor assembly where multitude of metal electrodes are of same metal and they do not participate in the reaction.

Still another object of the invention is to provide a reactor assembly where demetallation of heavy hydrocarbons is performed by the flow of electrons through the metal plates.

### SUMMARY OF THE INVENTION

The present invention discloses a novel reactor assembly [A1] which aims at increasing the reaction rate between three phases containing two immiscible liquid phases and one gaseous phase, wherein electricity does not result in electrolysis of the fluid medium. In this invention only electrical energy is used to supply the activation energy by energizing the molecules and it is ensured that electricity is used in form of flow of electrons and also teaches the methods of injecting electric current in the reaction system for enhancing the reaction rate of oxidative and reactive extraction of metals from the hydrocarbons.

### BRIEF DESCRIPTION OF THE ACCOMPANYING DRAWING

FIG. 1 shows the schematic diagram of the reactor assembly according to the present invention.

### DETAILED DESCRIPTION OF THE INVENTION

The present invention discloses a new reactor assembly which is required for the invented way of increasing the reaction rate occurring between multitude of phases, which has at least one aqueous phase. In this reactor assembly, a Continuous Stirred Tank Reactor (CSTR) type reactor assembly, which is well known in the prior art, has been used after modification. The agitator and baffle arrangement of the CSTR type reactor have been retained. These are required for achieving intimate contacting between two immiscible liquid phases, of which one is petroleum oil and other is aqueous phase containing various chemical reagents. In the prior art, the rate is increased by utilizing temperature or catalyst which may be homogeneous or heterogeneous.

The reaction can, however, be further increased by deploying external sources of energy such as microwaves, electromagnetic waves such as infrared, visible, UV, etc., ultrasound waves or electric current. The electric current is generally employed on the principles of electrochemistry. The electrical energy can be utilized in two ways: first in electrochemical way i.e. by donating electrons and secondly as pure to stimulate the molecules energy. The present invention discloses the use of electricity as only energy and methods of injecting electric current in the reaction system for enhancing the rate of reaction of oxidative and reactive extraction of metals from the hydrocarbons. The present invention uses the electric energy solely for energizing the molecules taking part in the reaction, but it does not participate in the reaction as in the electrochemical reactions.

The reactor assembly according to the present invention employs two or more metal plates which are the means of injecting the electrical energy in the surrounding liquid-liquid medium, which is in completely mixed condition. The present invention ensures this by using all the plates of same metal, whereby they do not act as electrodes. Instead, they merely act as the means of introducing a current of electrons in the liquid. No standard reference electrodes are used. By utilizing the current in this way, the molecules taking part in the reaction are energized and reaction rate is increased. At the same time the metal atoms of the plates do not take part in the reaction, which is an essential condition for accelerating reactions such as metal reduction from petroleum oils utilizing the reactive extraction by aqueous medium containing various reagents.

The CSTR types of reactors are generally used for studying reaction kinetics for the new reaction. They offer the advantage that the mixture has completely mixed phase hydrodynamics, hence no concentration gradients or temperature gradients exist in any spatial direction. Therefore, they are preferred where complete mixing is desired from kinetic point of view.

The CSTR type of reactor is well known in the art and is used where reaction between two or more phases of liquid, gas or solids are involved. The solid phase may be in finely dispersed form or enclosed in catalyst basket above or around the agitator impellers. The baffles are meant for creating turbulence and hence they aid in the mixing of phases.

The temperature and catalyst are factors which increase the rate of reaction. There are other sources of energy which may be utilized to energize the molecules taking part in the reaction. Electrical energy, electromagnetic waves such as Infrared, visible, UV, etc., microwaves, ultrasounds waves and other sources of energy are widely employed to facilitate or to increase the speed of the reaction. These sources of energy are employed for a variety of reasons. The most important one is, when the one of the reactants is temperature sensitive, the utility of temperature for speeding up the reaction becomes limited. The reactions involving temperature sensitive heavy petroleum feed stocks are one of the examples.

Electrical energy can be deployed for speeding up the reaction rate in different ways. For example, in desalters, a static form of electrostatic force is used to energize and in turn make the water droplets in to dipoles. It can be used in the form of flow of electron or current. In this method, conventionally, two electrodes are involved having different electron potentials. Thereby facilitate the preferential flow of electrons from one electrode to the other.

The electric current can be in any form such as AC, DC or any other waves. If there is no liquid medium which is conductive to the electric current, the circuit will remain incomplete and no current will flow through the metal plates. Therefore, it is imperative that at least one of the liquids has to electrically conductive. Then there is electrical contact between these two or more metal plates through the surrounding liquid medium.

The agitator assembly is in the centre of the reactor as known in the art and is designed to mix all the liquids with minimum dead regions within the reactor. A plurality of metal plates carrying current are longitudinally placed along the perimeter, defined by the flow of liquids being agitated. The said metal plates must be located at maximum possible distance between them. The metal plates thus enclose the agitator assembly. The metal plates carrying current are placed sufficiently above the bottom of the reactor vessel and preferably above the line defined by the bottommost part of the agitator. The height of the longitudinally oriented metal plates carrying current is such that they should always be submerged in the liquids, even when the agitator impellers are at their highest rotating speed. The preferable height should be approximately equal to 50% of the height of the reactor.

The impellers of the agitator should be such that they should form minimum vortex of liquids at the centre of reactor. There are numerous types of impeller designs available in the art. The speed of impeller must be enough to mix intimately all the constituents in the reactor.

The baffles are mounted on the reactor wall by numerous ways known in the art. Their design should be such that they create appreciable turbulence for the liquids to be completely mixed. Their geometry of shape should be such that they offer maximum resistance to the layers of liquids near the wall. Their orientation should be such that they cover all the liquids filled in the reactor.

It is important that in the present invention, the electric circuit is electrically insulated from all the other conducting parts of the reactor assembly except the said liquid medium, so that the metal plates can provide electric current for energizing only the molecules of the various chemical reagents present in the surrounding liquid medium. The metal plates carrying current are mounted on the supporting rods by welding or screwing, or alternatively, they can be left free to rotate by the fluids moving around them. If they are fixed then their orientation is such that they offer least resistance to the flow of liquids in the reactor. In other words, if they are fixed ones, they should be facing the agitator impellers. The metal plates are located at such height that they cover most of the liquid height but always remain submerged in the liquids. The metal plates are mounted vertically such that their bottommost part remains at the level defined by the bottommost part of the agitator impellers. The metal plates are of such a width that they offer least possible resistance to the flow of liquids in which they are submerged, their preferable width being 1 mm to 10 mm or more preferably 4 to 6 mm. The metal plates of are of the same metal to avoid detachment of metal atoms from metal plates and only serves as the means of transferring of electrons from the metal plates to the liquids into which they are fully immersed, so that the reaction is expedited. The metal plates are made from good conducting metals such as copper, aluminum, lead, zinc, iron, stainless steel etc. The metal plates (5) are electrically insulated from all parts of the reactor assembly (1) and the electrical circuit is completed only by the flow of electrons or current through the liquids into which they are immersed.

If oxygen source is present in the reactions that are taking place, the maximum temperature that can be employed to speed up the reaction is limited. Under such conditions, increasing the reaction temperature is likely to facilitate undesirable side-reactions of aromatics and multi-ring aromatics oxidation, which may lead to unstable products. Therefore, other sources of energy required to speed up the reaction and in particular electrical energy in form of flowing of electrons through the conducting medium is a preferred option.

Reactive extraction of organo-metal compounds, which are present mainly in the form of porphyrin-like structures in the petroleum oils or heavy crude oils, can be done by contacting said metal-containing oil with an aqueous solution of various chemical reagents. In the process, the metal from the metal-containing molecules are removed by oxidation. The oxygen for this oxidation is used either in molecular form or in any other active form by utilizing oxygen-emitting molecules. Then the oxidized metal is extracted in the aqueous medium. The aqueous medium is maintained in either acidic or basic pH levels, depending on the approach for the reaction used. The transfer of oxygen from aqueous phase to oily phase and transfer of oxidized metals from oily phase to aqueous phase are generally aided by phase transfer catalysts. The oily phase can be any heavy hydrocarbon stream consisting of organo-metal compounds and/or inorganic metal compounds.

The chemical reagents employed in the said aqueous medium are for performing various functions of the mechanism of reaction. Some alkaline materials are used to keep the solution in strongly alkaline pH range. These alkaline materials can be sodium hydroxide, potassium hydroxides, amines, or any chemicals to maintain a pH value above 7. Alternatively, some approaches use strong acidic medium such as nitric acid, sulfuric acid or other acids. In this approach the reactions are carried out in acidic pH domain (1 to 7). This approach tends to oxidize the aromatics in the heavy oil phase along with the metal compounds. This leads to instability. If the extent of reaction is large, the precipitation of heavier fractions such as asphaltenes, resins, and multi-ring aromatics of oil due to oxidation becomes inevitable.

Phase transfer catalyst such as onium salts are used for transferring materials across the phase boundaries. The phase transfer catalysts usually constitute one polar end and another non-polar end in the molecules and they preferentially remain at the phase boundaries of the oil and aqueous phases. Alternatively the phase transfer catalysts may be some chemicals which are miscible with both the phases involved. In this way they can move from phase to phase across the phase boundaries. There are various phase transfer catalysts known in the art such as quarternary ammonium salts, various chelating and metal-complexes, etc.

Other chemicals that can be employed in the aqueous medium are demulsifying agents to facilitate easy separation of oil and aqueous phases after their intimate contacting. These agents increase the rate of phase separation by getting accumulated on the phase boundaries and increasing the rate of accumulation of sub-micron sized liquid particles of similar phases.

The source of oxygen can also be in various forms. The source can be gaseous or a chemical reagent, which on dissolution in the water gives out highly active nascent oxygen, such as, peroxides, chlorides, etc. The peroxides are preferred because they do not contaminate the products with harmful chlorides, etc. But peroxides are very strong oxidizing agents; therefore, they should be used with precaution. The gaseous source of oxygen-supplying molecular oxygen can be yet another option. Though the reactivity of molecular oxygen is very low, they are still preferred because of minimization of other side-oxidation reactions. Such oxygen is used in association with certain types of speciality chemicals which can combine with this oxygen and facilitate the selective oxidation of metal compounds in the oil.

The invention will now be described in an explary embodiment as depicted in the accompanying drawing. However, there may be other embodiments of the same invention, all of which are deemed covered by this description.

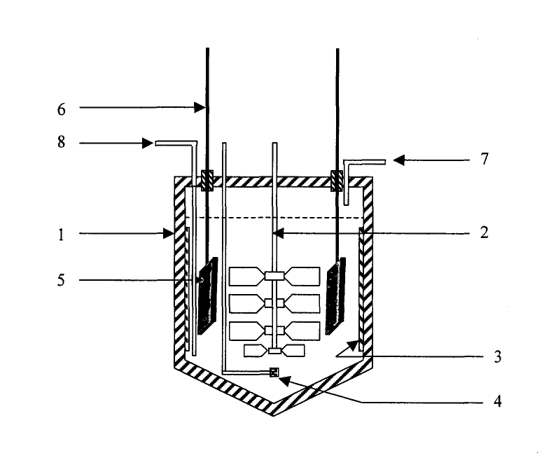

As shown in FIG. 1, the reactor assembly (1) according to the invention contains agitator (2) and baffles (3). Two immiscible liquids are fed through inlet pipe (8) either batch-wise or continuously to the reactor assembly (1). Into this mixture a gas is continuously passed via sparger (4). The gaseous stream used is air. The gas exits reactor (1) via outlet (7) under pressure control. The gas sparger is placed in the bottommost part of the reactor, thus aiding the agitator in mixing the liquids by creating turbulence. The gas sparger (4) is located below the bottom-most part of agitator (2) and metal plates (5). The sparger is sized such that it creates micron sized gas bubbles in the reactor, so as to provide enough mass transfer area and hence achieve higher mass transfer rate for reactants from gas phase to liquid phase. This gas may contain one or more reactant constituents in required levels of concentrations.

Metal plates (5) are placed longitudinally in the liquid-liquid mixture of reactor (1) with continuous agitation and gas sparging as shown in the FIG. 1. The metal plates are positioned in the vicinity of the reactor wall, but not touching the wall. The metal plates (5) are vertically oriented, and can be supported from top, bottom or sides of the reactor by tiny rods.

The metal plates (5) can be constructed as thin solid plates or holed throughout or can be made of wire meshes.

The metal plates (5) are attached to supporting rods (6) which are electrically insulated from the rest of the reactor. The supporting rods (6) are connected to a current source and are used for carrying current from the current source (AC or DC) to the metal plates. The metal plates are made of the same metal so that they serve as current supplying means to the reaction mixture. Any type of current, whether AC or DC or any other wave form can be utilized.

The voltage maintained across the metal plates (5) can be of the order of 1 to several thousands volts and the current densities involved can be 1 to several thousand mA/cm². The said voltage is sufficient to give appreciable amount of current in a given liquids into which the metal plates are dipped.

The agitator (2) is located in between the metal plates (5).

The reactor is to be equipped with other accessories that are essential for such kind of reaction such as thermocouple and its well, pressure tapping nozzles, pressure safety devices, etc. The pressure maintained in the reactor is just sufficient to maintain all the liquid reactants in the state of liquid.

The liquid reactants that are being used can be continuously introduced through inlet pipe (8) and taken out along with gases from outlet pipe (7). Alternatively, they can be introduced in batches with continuous flow of gases for a duration which is sufficient for the reaction. Then the liquids may be allowed to cool and separate. If the liquids are continuously fed and taken from the reactor then the means of level control of liquid which are known in the art may be provided. The liquid level is to be maintained in such a way that all of the reactor internals such as agitator impellers, baffles, metal plates carrying current and gas sparger are submerged in the liquids. Generally, 80% of the reactor height is to be maintained full of liquid.

We claim:

1. A reactor assembly (1) for improving reaction between two immiscible phases forming a reaction mixture, the mixture containing at least one electrolytically conducive liquid phase, for metal reduction of hydrocarbons comprising of:
agitator (2),
baffles (3),
gas sparger (4),
a plurality of plates (5) made of the same metal,
supporting rods (6),
outlet pipe (7), and
inlet pipe (8), characterized in that the metal plates (5) are placed longitudinally in the reaction mixture of reactor (1) with continuous agitation and gas sparging and are attached to supporting rods (6) which are connected to a current source.

2. The reactor assembly (1) as claimed in claim 1, wherein the reactor (1) is a CSTR type reactor assembly.

3. The reactor assembly as claimed in claim 1, wherein the said metal plates (5) are electrically insulated from the rest of the reactor except the reaction mixture.

4. The reactor assembly as claimed in claim 1, wherein the metal plates (5) can be constructed as thin solid plates or holed throughout or can be made of wire meshes.

5. The reactor assembly as claimed in claim 1, wherein the current source can be AC or DC or any other wave form.

6. The reactor assembly as claimed in claim 1, wherein the metal plates (5) carrying current are attached to the supporting rods (6) by welding or screwing, or are left free to rotate by the fluids moving around them.

7. The reactor assembly as claimed in claim 1, wherein the metal plates (5) are positioned in the vicinity of the reactor wall, but not touching the wall.

8. The reactor assembly as claimed in claim 1, wherein the metal plates (5) are vertically oriented, and can be supported from top, bottom or sides of the reactor by tiny rods.

9. The reactor assembly as claimed in claim 1, wherein the plurality of metal plates (5) are located at maximum possible distance between them.

10. The reactor assembly as claimed in claim 1, wherein the metal plates (5) are located at such height that they cover most of the liquid height but always remain submerged in the liquids.

11. The reactor assembly as claimed in claim 1, wherein the metal plates (5) are mounted vertically oriented with their bottommost part at the level defined by the bottommost part of the agitator impellers.

12. The reactor assembly as claimed in claim 1, wherein the metal plates (5) have a preferable width between 1 mm and 10 mm and more preferably between 4 and 6 mm so that they offer least possible resistance to the flow of liquids.

13. The reactor assembly as claimed in claim 1, wherein the agitator (2) is located in between the metal plates (5).

14. The reactor assembly as claimed in claim 1, wherein the gas sparger (4) is located below the bottom-most part of agitator (2) and metal plates(5).

15. The reactor assembly as claimed in claim 1, wherein the metal plates (5) are made from good conducting metals selected from copper, aluminum, lead, zinc, iron and stainless steel.
